(19) United States
(12) Patent Application Publication
(10) Pub. No.: US 2004/0207526 A1
(43) Pub. Date: Oct. 21, 2004

(54) Structural improvement for a vehicle multifunctional identification and management device

(76) Inventors: Lawrance Liao, Rancho Palos Verdes, CA (US); Pamela Liao, Rancho Palos Verdes, CA (US); Susan Liao, Rancho Palos Verdes, CA (US)

Correspondence Address: APEX JURIS, PLLC, 13194 EDGEWATER LANE NORTHEAST, SEATTLE, WA, 98125, US

(21) Appl. No.: 10/414,996

(22) Filed: Apr. 16, 2003

(51) Int. Cl. G08B 13/14

(52) U.S. Cl. 340/572.1; 340/426.1

(57) ABSTRACT

The present invention relates to a multifunctional identification and management device for vehicles that implants a chip in the automobile and the license plate for identification and comparison with comparison numbers or data provided. By comparing the comparison number built in the two chips, a specific detector sends out an error message if the numbers do not match. If the comparison numbers or data matches, the policemen, security guard or parking lot manager can examine the identity of the automobile, ban or fine for violating the law as well as emit unusual frequency or signal to notify the police station automatically, so as to enhance working performance and prevent automobiles and license plate from being stolen and being used in a crime.

### BACKGROUND OF THE INVENTION

1. Field of the invention

The present invention relates to a multifunctional identification and management device for vehicles, especially the design that implants a chip into an automobile and a driving license plate for comparison and identification so as to secure data from being changed and used illegally while reduces car larceny and policemen's burden.

2. Description of the prior art

Due to the high larceny rate for automobiles and the slim chance to find the car stolen, burglarproof has become more and more important nowadays. From police office, vehicle factories, insurance industry to the owners, burglarproof of automobiles has been invested with great efforts, in the hope of preventing automobiles from being stole.

Most of the various burglarproof solutions are negative in which automobiles are locked by several locks, trying to make it difficult to open the lock and thus drive the thief away. From the endless automobile larceny, however, it seems locks is not a good solution as the burglarproof effect provided is quite limited. Therefore, we must find another way out.

To prevent automobiles from being stolen, we must know the way by which the thief get rid of booties. Normally, the thief must change the license plate or the automobile itself to prevent the stolen automobile from being recognized. Moreover, stolen automobile or license plate might become the thiefs tool to commit a crime as in many news reports where stolen automobiles are used in a crime.

Furthermore, policemen are critical in the investigation of an automobile larceny. In such a case, policemen usually set up a roadblock first and then inquire each suspected automobile. Yet, the way the thief changes the automobile mentioned above prevents the policemen from comparing the information with the data of all stole automobiles immediately, thus reduces the effect. What's worse, the policemen have to investigate and inquire in many ways, which is not only inefficient but also make them fail to defend criminals' attack; therefore, the policemen may lose their life and social security being damaged.

Apparently, automobiles must be equipped with an unchangeable device to reduce automobile larceny and enhance the policemen's security being on duty. In this way, the thief won't be able to sell the stolen automobiles or use it in a crime, nor do they attempt to steal the automobile or the license plate. The inventor of the present invention was devoted to finding a solution and accomplished structural improvement for automobiles.

### SUMMARY OF THE INVENTION

The main objective for the present invention is to provide a multifunctional identification and management device for vehicles that implants a chip in the automobile and the license plate for identification and comparison. By comparing the comparison number built in the two chips to see if they match, it is possible to reduce the thiefs intention to steal the automobile or using the car and the license plate, thus reduces automobile larceny.

Another objective for the prevent invention is to provide a multifunctional identification and management device for vehicles that allows the policemen to perform detection rapidly by means of the electric utilities. This not only accelerates the policemen's examination of all automobiles and prevent them from leaving out any automobile but also reduces their burden, enhance their working performance and efficiency and reduce the risk of being attacked by the criminals.

The present invention is to add a chip in the automobile and the license plate for identification and comparison with comparison numbers or automobile information built in. Information in the chips of the automobile and the license plate must be executed by the vehicle management station when the owner applies for a license plate. The information of the chip in the automobile must match that in the license plate; otherwise, an error message occurs and errors are detected by specific scan devices.

The drawings disclose an illustrative embodiment of the present invention which serves to exemplify the various advantages and objects hereof, and are as follows.

### BRIEF DESCRIPTION OF THE DRAWINGS

FIG. 1 is a three-dimensional illustration for the structure of the automobile in the present invention.

FIG. 2 is a three-dimensional illustration for the structure of the license plate in the present invention.

### DETAILED DESCRIPTION OF THE PREFERRED EMBODIMENT

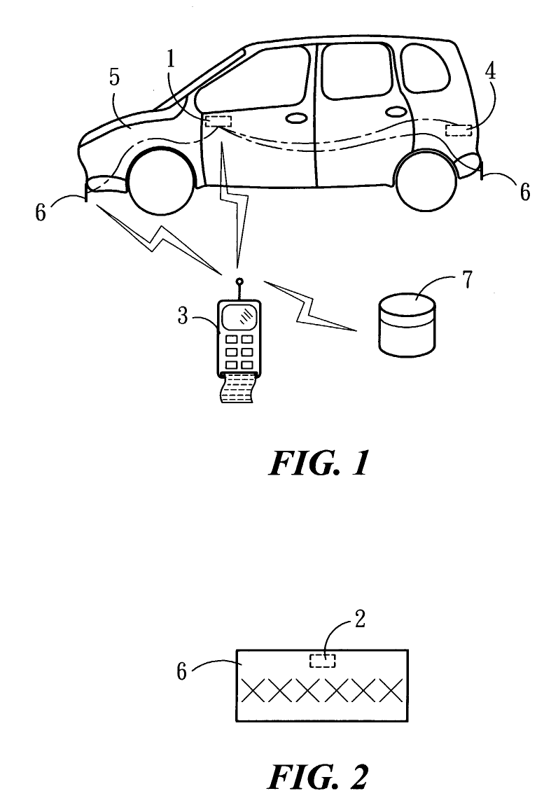

Please refer to FIGS. 1 to 2. The multifunctional identification and management device for vehicles contains a vehicle identification and comparison chip 1, a license plate identification and comparison chip 2 and a scanning detection and reception device 3. The one-pass or specially configured vehicle identification and comparison chip 1 is implanted in an automobile 5 or vehicle (not in this figure) (similar to the warranty label on a product that loses its validity to the product once being departed from the product so as to prevent illegal usage). The vehicle identification and comparison chip 1 has the comparison number or other information for the vehicle so as to facilitate future examination and identification. The license plate identification and comparison chip 2 is placed in the license plate 6 of the automobile 5. Different kinds of automobiles may possess different amount of license plate 6. When the owner of the automobile 5 applies for the driving license plate, the license plate 6 is input with the data about the automobile and the comparison number. The vehicle management station input the raw data about the automobile 5 provided by the manufacturer and the user-customizing password (or an officially given password) and then give the owner the vehicle identification and comparison chip 1, the license plate identification and comparison chip 2 and the license plate while requires the owner to place the vehicle identification and comparison chip 1 on the automobile 5 at where it can be scanned (may follow the police office's regulations). The data about the automobile 5 and the comparison number are then recorded in the license plate identification and comparison chip 2 of the license plate 6, which is then given to the owner alone with the automobile 5 (and inform the owner of the officially given password, if there is one). The user-customizing password (or the officially given password) of the automobile is recorded in the database 7 of the vehicle management station. Inside the police station's system there is a scanning detection and reception device 3, which is mainly used by the policemen or the parking lot manager. These people first scan the license plate identification and comparison chip of the license plate 6 on the automobile 5 for detection and then scan the vehicle identification and comparison chip 1. Next, they link to the database of the vehicle management station 7 accordingly and require the automobile's user-customizing password (or the officially given password) for comparison. In this way, they can determine the validity of the automobile.

To help the policemen with their work, the placement of the above vehicle identification and comparison chip 1 and the license plate identification and comparison chip 2 is very important. The vehicle identification and comparison chip 1 may be placed by the owner at his/her will or on the basis of the police station's regulations, such as nearby the cockpit or the window, which is done by pasting or through other methods to have it fixed inside the automobile 5. If someone attempts to detach the vehicle identification and comparison chip 1, which is made with one-pass design or special configurations to have it fixed inside the car, the detached vehicle identification and comparison chip 1 would be considered damaged. In this way, the risk of a stolen automobile 5 being used illegally is reduced along with the criminal's attempt to steal the automobile 5. Since the license plate identification and comparison chip 2 is embed or hidden inside the license plate 6, making it difficult to separate from the license plate 6, the license plate identification and comparison chip 2 taken apart by the criminals is considered damaged and the comparison between the vehicle identification and comparison chip 1 and the license plate identification and comparison chip 2 fails, thus facilitates the detection of the police station's system.

It is possible that the owner's license plate 6 is stole or the automobile 5 is damaged, resold, transferred or cancelled that requires applying for a new license plate with a different license plate number. In these cases, the license plate 6 must be changed or the vehicle identification and comparison chip 1 be reconstructed. Therefore, the vehicle management station must reconstruct the data according to the files, making a new license plate identification and comparison chip 2, and redistribute the license plate 6 or the vehicle identification and comparison chip 1. Then, the scanning detection and reception device 3 is able to compare the identity of the automobile 5 least misjudgment or disputes occur.

According to the above devices, the detection of the policemen states as follows:

1. The policemen scan and detect the license plate identification and comparison chip 2 in the license plate 6 of the automobile 5 with the scanning detection and reception device 3.

2. The policemen scans the vehicle identification and comparison chip 1 with the same scanning detection and reception device 3;

3. The scanning detection and reception device 3 links to the database 7 of the vehicle management station to identifies the validity of the automobile 5 and get the password from the database 7 which is shown on the monitor of the scanning detection and reception device 3.

4. The policemen then ask the driver for the password of the automobile.

If any errors such as conflicting password appear in any of the above steps, the scanning detection and reception device 3 display error message. Then the policemen are able to perform sequential work.

Advanced technology allows automatic comparison between the vehicle identification and comparison chip 1 and the license plate identification and comparison chip 2 by connecting to database. Therefore, the policemen only need to choose either the vehicle identification and comparison chip 1 or the license plate identification and comparison chip 2 for detection (a combination of the above step 1 and 2) to complete validity identification of the automobile 5. On the other hand, the above vehicle identification and comparison chip 1 and the license plate identification and comparison chip 2 can be connected to a frequency generator 8 separately or jointly. When either side of the vehicle identification and comparison chip 1 or the license plate identification and comparison chip 2 becomes unusual, the frequency generator 8 is launched and emits extraordinary frequency. The scanning detection and reception device 3 is built with a signal receptor able to detect the unusual frequency by time or location, so as to track suspicious vehicles and eliminate crimes. The installing location of the frequency generator 8 can be decided by the vehicle manufacturers so as to make dismantling or damage more difficult. The above signal receptor can also be installed by the authority along with the speed-measuring camera on the highway. The scanning detection and reception 3 of the present invention can be attached with several additional devices, such as wireless network, ticket writing device, hand-writing LCD panel, printer, digital camera, database, voice control device and GPS or other electric devices. The database able to connect to the police station or vehicle management station records the latest regulations and information. The ticket writing device issues the ticket in accordance with the driver's violation, which is printed by the printer and handed to the driver after the driver signed on the LCD panel for confirmation. In cases of a large number of automobiles parking illegally, the policemen only need to set up the scanning detection and reception device 3 with illegal fact and regulations and then scan the license plate identification and comparison chip 2 on the license plate 6 to print tickets rapidly and then put the ticket on the windshields. Also, the scanning detection and reception device 3 can be used by the parking manager or set up at the parking lot entrance to write out and print ticket in the same way. Evidence can also be collected at any time by the equipment of digital camera. All work can be controlled by voice, allowing the policemen to complete other work. Therefore, the scanning detection and reception device 3 reduces the manager's burden effectively while have all conventional equipment used in performing duties integrated, such as tickets, pencils and paper, camera, etc. With this device, the policemen no longer need to carry lots of equipment when performing duties, which reduces the risk of being attacked when they are writing out a ticket.

With the above devices, the present invention is able to have other enhanced identification and comparison chip 4 that records other information and can be integrated with the vehicle identification and comparison chip land the license plate identification and comparison chip 2 inside the automobile 5. The content and configuration of the enhanced identification and comparison chip 4 may be customized by the owner's, which makes replication and falsification more difficult and enhance the security of the automobile 5.

Compared with traditional technology, the multifunction identification and management device for vehicles have the following characteristics:

1. The present invention saves the examination times of the policemen, which reduces the impact on traffic while provides better detection. Missing and misjudgment is reduced and mistaken tickets are lessen.

2. The present invention prevents the occurence of danger against the policemen during writing out a ticket, helping them write out the ticket rapidly and safely while keep an eye on any incident, thus saves time, labor and material as well as protect them from being attacked by criminals.

3. The present invention saves correct information about the automobile inside the identification chip, which facilitates the management of automobiles while offer help in the minimum of time.

4. The present invention has good detection that reduces criminal's attempt of committing a crime and the possibility of the stolen autobmoile being used illegally, which in turn reduces larceny.

5. The user-customerizing password (or officially given password) used in the present invention is only known to the owner and saved in the database of the vehicle management station; therefore, criminals wont' be able to search and get the confidential number. Even if they do get the source code and the comparison password, they won't be able the user-customerizing password (or officially given password), and the security is guaranteed.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims

What is claimed is:

1. A multifunctional identification and management device for vehicles, characterized by:
a chip for vehicle identification and comparison implanted in automobiles and vehicles where it can be scanned and has comparison numbers or vehicle data built in;
a license plate identification and comparison chip implanted in a license plate with comparison numbers or vehicle data built in; and
a scanning detection and reception device for policemen and relative personnel on duty, able to scan, detect, receive and compare data with said vehicle and license plate chip's data as well as link to vehicle management station's database to make comparison so as to judge data's validity.

2. The multifunctional identification and management device for vehicles of claim 1, wherein said vehicle identification and comparison chip is issued from a vehicle management station and is implanted in automobiles and vehicles; said chip possesses particular detachment requirement to avoid being used for illegal purposes.

3. The multifunctional identification and management device for vehicles of claim 1, wherein said license plate identification and comparison chip is issued from a vehicle management station and is implanted in a license plate that is placed at certain place of an automobile and vehicle.

4. The multifunctional identification and management device for vehicles of claim 1, wherein said vehicle identification and comparison chip and said license plate are made with one-pass design or special configurations and can't be departed from said vehicle.

5. The multifunctional identification and management device for vehicles of claim 1, wherein an automobile can have other enhanced identification chips to make modification more difficult.

6. The multifunctional identification and management device for vehicles of claim 1, wherein said vehicle identification and comparison chip and said license plate identification and comparison chip can complete comparison by automatic linkage and said scanning detection and reception device only needs to choose either one.

7. The multifunctional identification and management device for vehicles of claim 1, wherein said scanning detection and reception device can also have a fining device, a hand-writing LCD panel and a printer for the convenience of fining or generating parking bills.

8. The multifunctional identification and management device for vehicles of claim 1, wherein a vehicle management station's database records a user custom password or an official password.

9. The multifunctional identification and management device for vehicles of claim 1, wherein said vehicle identification and comparison chip and license plate identification and comparison chip can be connected to a frequency generator separately or jointly, said scanning detection and reception device is built with a signal receptor able to emit unusual frequency when said chips becomes unusual; that is, said frequency generator emits unusual frequency or signal and said frequency or signal is then detected by said scanning detection and reception device.
